(19) United States
(12) Patent Application Publication
(10) Pub. No.: US 2017/0144506 A1
(43) Pub. Date: May 25, 2017

(54) Automatic Temperature Control System for Unattended Motor Vehicles Occupied by Young Children or Animals

(71) Applicant: William H. McGrath, JR., Whiting, NJ (US)

(72) Inventor: William H. McGrath, JR., Whiting, NJ (US)

(21) Appl. No.: 15/356,956

(22) Filed: Nov. 21, 2016

Related U.S. Application Data
(60) Provisional application No. 62/259,753, filed on Nov. 25, 2015.

(51) Int. Cl. B60H 1/00; B60H 1/32

(52) U.S. Cl. CPC B60H 1/00978; B60H 1/00742; B60H 1/3222; B60H 2001/3255; B60H 2001/327

(57) ABSTRACT

A temperature control system that automatically operates the air-conditioning system of an unattended motor vehicle upon detecting the presence of persons or animals in the vehicle when temperatures sensed therein exceed a predetermined threshold.

### CROSS-REFERENCE TO RELATED APPLICATIONS

A Provisional Patent Application covering the invention described herein was filed on Nov. 25, 2015, and assigned Ser. No. 62/259,753.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

Field of the Invention

This invention relates to automatic temperature control systems for motor vehicles, in general, and to such a system operable to protect infants, young children, and/or animals left in an unattended motor vehicle as temperatures within rise beyond acceptable limits, in particular.

Description of the Related Art

As will be understood, in recent years there has been an alarming increase in the number of infants, young children and animals dying from heat exposure while occupying unattended motor vehicles. Criminally prosecuting those adults responsible for leaving these children or animals unattended has not proven to be an effective deterrent. Defending such prosecutions on the grounds that the vehicle was only left unattended for a few minutes has not been very persuasive to a jury or judge, and no matter how distraught the adult might be over the occurrence. State and Local Governments which enact legislation banning the practice of leaving such an occupied vehicle unattended serve to highlight the problem—yet the only actions that seem to have followed is an operator's lowering of his/her vehicle's windows somewhat so as to hopefully allow ambient cooler air to waft in while being away.

In an attempt to deal with the dangerous situations that such heat exposure could bring to the young child or animal occupant, many shopping centers and indoor malls have taken to the practice of having security patrols just drive around their parking lots and garages in an attempt to detect such conditions before yielding to disastrous results, and to somehow locate the vehicle owning shopper. The security and police patrols' generally leaving of informational pamphlets under the windshield wipers of all vehicles in the lot or garage as to the consequences of a temperature increase in closed vehicles is somewhat helpful, as is the reporting to store personnel by other shoppers of their seeing a young child or animal left within a parked vehicle where that circumstance should arise.

Nevertheless, and unfortunately so, many of these young children and animals continue to die each year from heat exposure because of human error, mistake, accident and momentary forgetfulness when leaving the vehicle unattended to carry out some minor chore or task. Unfortunately, forgetfulness is a human trait that cannot really be helped—and once an event happens, there is no recourse. Therefore, it will be appreciated that a preventative is needed, something more mechanical in nature as a machine or system, that will not be forgetful, being programmed to act over and over again, typically without fail.

### OBJECT OF THE INVENTION

It is an object of the invention to provide such a mechanically operable control system.

### SUMMARY OF THE INVENTION

As will become clear from the following description, the present invention recognizes this type of human error—no matter how innocent or accidental it may be—but acts to eliminate it from producing the heart-wrenching calamity which might inevitably follow. As will be seen, the invention describes an automatic temperature control system for these unattended vehicles for activation when a vehicle's occupant is unable by himself/herself or itself to take corrective action.

In accordance with the invention, an auxiliary motor is employed as part of a supplemental cooling system which comes into operation when temperatures rise to a predetermined (i.e. dangerous) level in the vehicle. An auxiliary battery is included as part of the supplemental system, powered by solar panels or strips built into the vehicle—as along either its front or rear dashboards, its windows, or its various panels (or in the case of a totally electric car, its own power source can be used to power the auxiliary motor).

Recognizing that an increased temperature generally lowers as the hours advance during the day, the solar energization and the battery construction of the invention are selected such that the battery charge need only be of sufficient capacity to last some 8-12 hours or so at the elevated temperature condition with recurring sunlight. Obviously, within such eight hour time frame, the operator would generally be expected to return to the vehicle in any event—with the belief that recognizing the temperature conditions inside the closed vehicle would then lead himself/herself to the manual temperature regulation of the standard compressor motor of the air-conditioning otherwise controlled automatically by the auxiliary motor of the invention. Thus, depending upon the parameters selected and designed, an automatic cooling of the inside could be had once a predetermined threshold temperature is reached. Continued cooling, would then last and be powered by the solar panels continuously as long as there was sunlight. If sunlight is not sufficient, then the charged batteries would take over until sunlight returns to power the auxiliary motor and then recharge the battery.

The present invention goes further, moreover, in affording a manner of determining whether an infant, young child or animal is present within the vehicle left unattended and to automatically cool a heated vehicle at such time. A first preferred way is to condition the energization of the supplemental auxiliary cooling system through the use of detecting a closed seatbelt being worn. If the seatbelt is closed, apparently it is being worn by someone in the vehicle, who needs to then be protected should the internal temperatures of the vehicle rise to the predetermined threshold. Effective in situations where an infant is in the vehicle (as where the seatbelt secures a child seat), or in the case of younger children strapped in who fall asleep, the invention also recognizes that certain older children are able to disconnect the seatbelt when the vehicle is not in motion and they are just sitting inside—and, certainly, most family pets are not seatbelted when being driven about. In these latter situations, the detection apparatus for activating the cooling cycle is accomplished through a motion detector since, at some time or another, either the older child or animal is going to wake and stir or move about. Such motion detection then, again, triggers the corrective action of the auxiliary motor automatically once the threshold temperature is reached.

Operating in these manners, therefore, obviates the possible problem with an alternative proposed solution of employing a “weight” type of sensor as a conditioning factor for the temperature control which, might become energized simply by the weight of one's briefcase being put on the seat, or a shopping bag filled with groceries, instead of by the weight of a child or animal on the seat.

And, as will be seen from the following description, the supplemental auxiliary cooling system of the invention operates through the use of this solar powered battery provided to control the auxiliary motor in engaging a second, added clutch on the compressor motor of the vehicle's air-conditioning system.

### BRIEF DESCRIPTION OF THE DRAWING

These and other features of the invention will be more clearly understood from a consideration of the following description, taken in connection with the single figure of the drawing, in which:

FIG. 1 illustrates a block diagram helpful in an understanding of the invention to effectuate this temperature control in an unattended motor vehicle.

### DETAILED DESCRIPTION OF THE INVENTION

As will be appreciated, circulating refrigerant vapors in a vehicle's air-conditioning system enters its compressor (located in the engine bay) where it is compressed to a higher pressure, resulting in a higher temperature as well. The hot, compressed refrigerant vapor is then at a temperature and pressure at which it can be condensed and routed through a condenser, usually located in front of the vehicle's radiator. There, the refrigerant is cooled by air flowing across the condenser coils and condensed into a liquid. The circulating refrigerant thus rejects heat from the system and the heat is carried away by the air. The condensed and pressurized liquid refrigerant is next routed through an expansion valve where it is undergoes an abrupt reduction in pressure. Such pressure reduction results in flash evaporation of a part of the liquid refrigerant, lowering its temperature. The cold refrigerant is then routed through the evaporator located in the passenger compartment such that the air (which is to be cooled) blows across the evaporator, causing the liquid part of the cold refrigerant mixture to evaporate as well. This, too, further lowers the temperature such that the warm air is therefore cooled. The refrigerant vapor is then routed back into the compressor to complete the refrigeration cycle.

As will be understood, the compressor is driven by the vehicle's engine via a belt and a clutch once the air-conditioning switch is turned on and the air-conditioning motor starts operating.

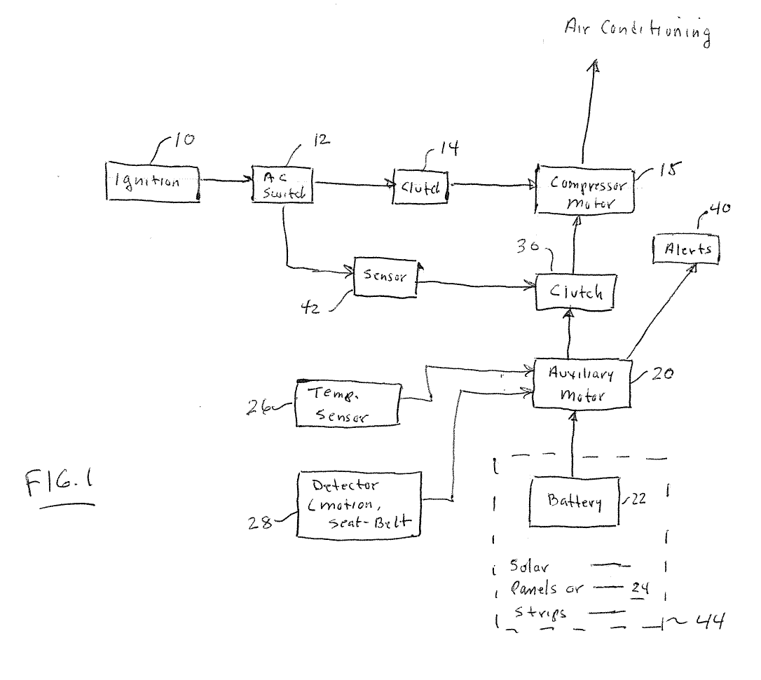

In FIG. 1, the vehicle's ON/OFF ignition switch is shown at 10, coupled by means of an air-conditioner control switch 12 to connect by a clutch 14 to the compressor motor 15 of its air-conditioning system. With the ignition “on” and the switch 12 activated, cooled air is introduced into the passenger compartment. With the ignition switch “off”, as when the vehicle is unattended, no cooled air is provided regardless of the temperatures within the passenger compartment. Similarly, with the ignition “on”, but with the switch 12 likewise “off”, no cooled air is provided either.

In FIG. 1, also, a separate, supplemental auxiliary electric motor is shown at 20, with a separate auxiliary battery 22 energized by one or more solar panels or strips 24 about the motor vehicle. The construction for the battery 22 may be such as to hold some eight hours of charge, sufficient to operate the auxiliary motor 20, on the assumption that the human operator of the vehicle would return in that length of time, or in recognizing, for example, that by that time lapse, heat temperatures would tend to lower and cool as the sun goes down.

Temperature sensing apparatus for this separate, supplemental auxiliary electric motor 20 is shown at 26 as being coupled along with this battery 22 to actuate this motor 20 once a threshold of temperature is reached, although upon command of a detector 28 which senses the motion of an occupant in the vehicle (an infant, child or animal), or one which senses a closed seatbelt connection for an infant or child strapped into a seat. In accordance with the invention, the sensing apparatus 26 is one which is enabled when the ignition switch 10 is “off”; and whether the air-conditioning switch 12 is “off” or “on”. In this way, as long as the battery 22 is adequately energized, or there is sufficient sunlight to charge it, any motion or seatbelt connection sensed in the vehicle will actuate the auxiliary motor 20 once the ambient conditions in the vehicle exceeds the predetermined threshold—for example, 80°-90° F. In other words, once the operator of the motor vehicle leaves, with the ignition turned “off”, or left “on” but without the control switch 12 selected for air-conditioning, the sensing apparatus 28 will take over once the applicable threshold temperature is reached. The separate auxiliary motor 20 then drives a second clutch 30 on the compressor motor 15 of the air-conditioning system to activate the air-conditioning to automatically control the internal temperature of the vehicle within its cab compartment.

To accomplish this in accordance with the present invention, the second clutch 30 is engagable with the compressor motor 15 once the auxiliary motor 20 is activated by the temperature threshold being reached under the control of the monitoring detector 28 sensing the motion of an occupant in the vehicle or the presence of a closed seatbelt. The operation is automatic in the sense that the refrigeration cycle is activated when the vehicle's engine is “off”, continuing for as long as the temperature I above the threshold.

That is to say, the air-conditioning system then becomes operative through the solar screen 24-battery 22-auxiliary motor 20 combination (or in the case of a total electric car, its own power source, as indicated by the box-notation 44 of FIG. 1), when the vehicle is not operating once the designated temperature is reached. When the driver returns to the vehicle and turns the ignition key “on”, additional sensors-42 in the vehicle would operate to prevent the second clutch 30 from engaging to operate the compressor motor 15, but only if the air-conditioning control switch 12 were activated as well—thereby bypassing the supplemental automatic temperature control components. If the control switch 12 were turned “on”, operation of the air-conditioning system by the driver would then follow in the normal, usual sense.

As such, the auxiliary air-conditioning system operates to maintain a coolness in the vehicle when the driver is away with the engine “off”, and, also, when the driver exits the vehicle leaving it running without the air-conditioning “on”. In this respect, setting the predetermined, designated temperature for the auxiliary cooling system would be set at the factory in accordance with the invention, so that no human error comes into play by the driver failing to set it, or by the sales showroom at the point of purchase failing to do so either. In this respect, human forgetfulness is not an issue—as the supplemental machine mechanism never forgets. And, in this respect, it will also be understood by those skilled in the art that this auxiliary air-conditioning system of the invention could be installed as an after purchase item for those vehicles already manufactured and operating.

As will be apparent, while the invention as so far described operates to automatically protect the child or animal occupant in the presence of somewhat extreme temperature conditions, further protections can be implemented by having the temperature sensing apparatus 26 also condition the auxiliary motor 20 to provide various “alerts”—either visual or audible to “flash” or “sound”—as a further warning to those in the vicinity of the vehicle that a child or animal is at risk within the vehicle's confines. These visual and/or audible “alerts” are shown at 40 in FIG. 1.

Such apparatus, while particularly useful in taking away from the vehicle's operator the possibility of making a mistake when getting out of the vehicle, also affords a similar protection where the operator himself/herself may become disabled when still within the vehicle; although disabled inside, the motion detection or seatbelt connection sensor of the unit 28 would continue to provide the benefits of keeping the temperature within controlled limits until an “alert” is observed, or someone comes upon the scene.

As will be appreciated, any electronic design for the sensing apparatus and for the controls of the motors employed could be had, and any appropriate design of the solar operated battery could follow (or of the electric power car source where appropriate). All that is required is a recognition that this degree of automatic control can be had based on a confluence recognizing the presence of some person or animal to be protected in the vehicle, and an exceeding of a predetermined temperature threshold, whatever it may be desired to be set at.

And, as will be understood, while a human's forgetfulness when leaving the vehicle unattended may never be overcome, the mechanical nature of the invention's applicability will be seen to continue on unimpeded regardless—both, as with affording the described protection for the child or animal left within the vehicle, or just for automatically engaging the auxiliary cooling system when the temperature sensing detector 26 becomes active in the presence of an excessive heat condition.

While there have been described what are considered to be preferred embodiments of the invention, it will be appreciated by those skilled in the art that modifications can be made without departing from the scope of the teachings herein. For at least such reason, resort should be had to the appended claims for a true understanding of the invention.

I claim:

1. An automatic temperature control system for an unattended motor vehicle equipped with an air-conditioning compressor motor driven by a first clutch upon actuation of an air-conditioner on-off switch of a motor vehicle comprising:
an auxiliary electric motor;
a second clutch coupling an output of said auxiliary electric motor to said compressor motor;
first means for sensing the temperature within said motor vehicle and for comparing it against a predetermined threshold; and
second means for sensing the presence of persons or animals within said motor vehicle;
with said auxiliary electric motor having first and second inputs respectively coupled to said first and second means for actuation thereby to operate said compressor motor upon sensing the presence of a person or animal within said motor vehicle and upon sensing a temperature therein beyond said predetermined threshold when said air-conditioner switch is in an “off” switch mode.

2. The automatic temperature control system of claim 1 wherein said auxiliary electric motor is solar powered with an included battery backup.

3. The automatic temperature control system of claim 2 wherein said auxiliary electric motor is solar powered by individual ones of solar panels and strips built into at least one of dashboards, windows, roofs and panels of said motor vehicle.

4. The automatic temperature control system of claim 2 wherein said auxiliary motor is solar powered with battery back-up for substantially 8-12 hours.

5. The automatic temperature control system of claim 3 wherein said auxiliary electric motor includes a second output to provide one of a visual and audible alert upon the sensing of a person or animal within said motor vehicle and of a temperature within said motor vehicle beyond said predetermined threshold.

6. The automatic temperature control system of claim 3 including third means for disengaging said second clutch when an ignition switch of said motor vehicle and said air-conditioner on-off switch are turned “on”.

7. The automatic temperature control system of claim 6 wherein said predetermined threshold temperature is set during the manufacture of said motor vehicle.

8. The automatic temperature control system of claim 7 wherein said predetermined threshold is preset to a range from 80° to 90° F.

9. The automatic temperature control system of claim 3 wherein each of said first and second means are always operationally enabled.

10. The automatic temperature control system of claim 9 wherein said second means includes a motion detector for sensing the presence of a person or animal within a cab compartment of said motor vehicle.

11. The automatic temperature control system of claim 9 wherein said second means includes a seat-belt closure detector for sensing the buckling-in of a person within said motor vehicle.

12. The automatic temperature control system of claim 9 wherein said auxiliary electric motor is powered from the power source of an electrically powered motor vehicle.
